(19) United States
(12) Patent Application Publication
(10) Pub. No.: US 2014/0143079 A1
(43) Pub. Date: May 22, 2014

(54) Penny Auction Sweepstakes

(71) Applicants: Lonnie G. Pope, Gainesville, GA (US); Christopher S. Fellows, Dacula, GA (US); Michael Ray Moore, Morris, AL (US)

(72) Inventors: Lonnie G. Pope, Gainesville, GA (US); Christopher S. Fellows, Dacula, GA (US); Michael Ray Moore, Morris, AL (US)

(21) Appl. No.: 13/682,168

(22) Filed: Nov. 20, 2012

(51) Int. Cl. G06Q 30/08

(52) U.S. Cl. CPC G06Q 30/08
USPC 705/26.3

(57) ABSTRACT

A system and method of integrating a penny auction and a sweepstakes includes presenting a split screen view to a user, with the split screen view containing a first portion and a second portion, the first portion displaying a penny auction and the second portion displaying a sweepstakes game, and receiving a request from the user to purchase one or more bids for use on the penny auction in the first portion of the split screen view. Based on the received request, the user is awarded one or more entries for the sweepstakes in the second portion of the split screen display.

### TECHNICAL FIELD OF THE DISCLOSURE

The present disclosure relates to games and entertainment and, more particularly, relates to a system and method for providing a penny auction tied to a sweepstakes to facilitate patronage of the penny auction.

### BACKGROUND OF THE DISCLOSURE

A penny auction system sells bids to customers at some nominal mount, e.g., 50 cents per bid, but the customer is only allowed to make a bid of some lesser amount, e.g., $0.01, at a time. As a result, as the bids mount, the actual purchase price of the item remains quite low; however, the typical penny auction company makes its profit on the 50 cents (or other amount) spent for every bid (As used herein, the term “penny auction” refers to an auction that works via this mechanism, whether the allowed bid is $0.01, $0.05, or some other amount).

By way of example, assume that the penny auction system has offered a 52-inch flat screen television with a starting bid set at $0.01. Assume the TV has actually cost the company $600 but the bids only go up to $68. It would appear that the company has lost $532, but because there were 6800 bids, the company actually grossed $3400 and netted $2800 plus the $68 that was bid by the winner. The winning bidder typically must also pay for any shipping and handling.

The penny auction provider maintains and launches a consistent stream of these type auctions on a penny auction website. At any time, there can be any number of auctions going on and these auctions may be stacked one after another with an array of different items to be auctioned off.

However, it is possible for a penny auction system to make less than its costs or to turn an insufficient profit if there is not enough traffic to its site. Therefore, it is important for such systems to be publicized and attractive to consumers. As they currently stand, however, it can be difficult to differentiate one penny auction system over another due to the similarities in offerings and methods of operation.

The present disclosure is directed to systems and methods that address one or more of the problems set forth above. However, it should be appreciated that the solution of any particular problem is not a limitation on the scope of this disclosure or of the attached claims except to the extent expressly noted. Additionally, the inclusion of any problem or solution in this Background section is not an indication that the problem or solution represents known prior art except as otherwise expressly noted.

### SUMMARY OF THE DISCLOSURE

In accordance with one aspect of the present disclosure, a method is provided for integrating a penny auction and a sweepstakes. In an embodiment, the method includes presenting a split screen view to a user, with the split screen view containing a first portion and a second portion, the first portion displaying a penny auction and the second portion displaying a sweepstakes game. A request is received from the user to purchase one or more bids for use on the penny auction in the first portion of the split screen view, and based on the received request, the user is awarded one or more entries for the sweepstakes in the second portion of the split screen display.

In accordance with another embodiment, a nontransitory computer readable medium is provided having thereon instructions for performing a method of integrating a penny auction and a sweepstakes. The instructions include instructions for presenting a split screen view to a user, with the split screen view containing a first portion and a second portion, the first portion displaying a penny auction and the second portion displaying a sweepstakes game. Also included are instructions for receiving a request from the user to purchase one or more bids for use on the penny auction in the first portion of the split screen view and instructions for awarding the user one or more entries for the sweepstakes in the second portion of the split screen display based on the received request.

Other features and advantages of the disclosed systems and principles will become apparent from reading the following detailed disclosure in conjunction with the included drawing figures.

### BRIEF DESCRIPTION OF THE DRAWINGS

FIG. 1 is a schematic screen view showing a penny auction and sweepstakes game in accordance with an aspect of the disclosed principles;

FIG. 2 is a flow chart showing a process in accordance with an embodiment of the invention;

FIG. 3 is a schematic network diagram showing a network configuration in accordance with an embodiment of the invention;

FIG. 4 is a schematic network diagram showing an alternative network configuration in accordance with an embodiment of the invention;

FIG. 5 is a schematic network diagram showing a further alternative network configuration in accordance with an embodiment of the invention;

FIG. 6 is a schematic network diagram showing yet another network configuration in accordance with an embodiment of the invention;

FIG. 7 is a schematic network diagram showing another network configuration in accordance with an embodiment of the invention; and

FIG. 8 is a data flow diagram showing data flow during acquisition and use of bid tokens and sweepstakes entries.

### DETAILED DESCRIPTION OF THE DISCLOSURE

The present disclosure provides a system and method based on a combination of a penny auction system with a sweepstakes website and/or program. When the customer goes to the penny auction website or location, he or she typically purchases a block of bids (also called bid tokens). These blocks may be available in different sizes such as 20 bids for $10 or 100 bids for $50. In exchange for the purchases of each bid, the customer receives, for example, fifty free sweepstakes points that are redeemable to allow the customer to participate in the sweepstakes. The sweepstakes and penny auction are displayed at the same time, e.g., adjacent one another on a screen or display so that the user can perform dual monitoring of the action in both activities.

The penny auction website or location owner may monitor and decide which game (or games) is creating the most business for the penny auction site. This is in keeping with the motivation of the owners to run the sweepstakes in a manner so as to generate more bid purchases to be used at the penny auction website.

At all times, the sweepstakes and the penny auction site or location are both run in strictest accordance with all relevant federal and state laws. For example, in accordance with the federal laws concerning sweepstakes, all customers could also receive at least one free opportunity to enter the sweepstakes by sending in a self-addressed, stamped envelope or by simply sending in an email to the company. This would mean that each time the customer did this they would receive one free sweepstakes opportunity.

The invention provides for the integration of the penny auction website and the sweepstakes promotion system. In one embodiment of the invention, the penny auction website or location (or any other type of information transfer and accessibility that would rely on a digital platform) allows a customer to purchase a bid or bids as described above. These bids may be in the form of digital tokens or simple credits to the customer's account or another suitable form to denote the purchase and ownership of bidding rights. As noted, in addition to receiving the bids for use on the auction site, the customer also receives credits, tokens, points or entry vouchers to play the sweepstakes games.

The sweepstakes games can range from the simple to the complex. The game might be a “match the number” or it might be one involving collecting a certain combination of player pieces or markers that result in a prize. It could be a game that involves correctly answering certain questions or putting thing in the correct order. It could also be as simple as revealing the value of the item won which would require no effort by the customer other than going to that particular page or site or clicking on a button.

The sweepstakes games envisioned by the inventors may also involve games that could combine chance and skill and closely resemble games played in casinos. These type games include, but are not limited to: poker, roulette, slots, bingo, blackjack and others. However, once again, it should be noted that none of these games involve gambling, but are simply games that are formatted in a sweepstakes configuration that involves free entries and a chance to win prizes that are monetarily based, such as cars or vacations, for example, or sums of cash.

In this particular configuration, the penny auction website is one specific website while the sweepstakes games would be housed or programmed into another website, but presented side by side for dual viewing by the user. Alternatively, as stated earlier, the locations of the auction or the sweepstakes may not be websites per se, but may be another digital form that allows the same type of accessibility to these functions.

In this configuration, the customer performs all of the normal tasks that are inherent to completing a bid on an auction site. With the credits, tokens or points given to the customer for sweepstakes entries, the customer then accesses another website or system (or digital portal) on the same screen and plays whatever sweepstakes games are provided. In an embodiment of the invention, this provides two separate entities that are independent of each other. For example, the penny auction website or location may be owned and run by one business while the sweepstakes may be owned and run by another.

In a preferred configuration based on the above scenario, the customer does not need to go to a separate location to play the sweepstakes and, in fact, the two functions are running side-by-side in the user's display. In this configuration, the customer buys the bids as described above and uses them to try and outbid other customers. As the customer watches the bid totals and timing factors on the various items he or she is bidding on, they may also be playing the same type sweepstakes game that was described in the previous configuration.

The screen that the customer is viewing on the website or computer (or other digital forum) may be a split screen with one side being the auction side while the other is the sweepstakes game side. The screen could also be predominately occupied by the sweepstakes with a smaller block (or blocks) being devoted only to the auctioned items that the customer is bidding on. In other words, there is no requirement that the two portions of the screen (penny auction and sweepstakes) be equal. No matter the layout, the screen would allow a multi-tasking of two or more events: single or multiple bid observation and interaction and single or multiple sweepstakes interaction.

Another configuration involves the customer actually participating at a physical location. Based on either of the two scenarios above, the customer would enter a location and purchase bids there. As will be seen in discussing the figures, this location may be referred to as a point of sale. These bids could be sold to a new user by way of setting up an account with the system. For example, the player would be issued a password for the penny auction website. This password could be temporary to allow the customer to change it at their convenience or it could be their permanent password for this particular account.

These bid purchases may be used on the Internet penny auction site or may be used at terminals at the location of purchase (or other locations that are in the same network) which are interlinked with a closed network.

An additional configuration would be a combination of either one of the first two configurations with the last configuration. This configuration would include private terminals (home computer, digital phones, PDA's, etc.) and public terminals available in locations that allow for the physical act of purchasing bids and then using that purchase at a terminal at the same location.

Another aspect in an embodiment of the invention pertains to the accounting mechanisms in place. On the penny auction side, a central Internet server or server bank (or central server for closed network systems) processes the purchase of all bids, the placement of the bids and the awarding of the winning bid for each item being auctioned in an embodiment of the invention. The central server keeps track of each individual account and the number of bids that have been purchased. It also furnishes to the owners or managers of the penny auction website all information needed to finalize the purchase of the item and the shipping required to make sure the item is received by the winning bidder. If the item being bid upon is a block of bids, then the server also adds that number of bids into the winner's account.

On the sweepstakes side, the central server (or servers) keeps track of the games that are being played and the customers playing them. Each customer is linked to the specific account that is used on the penny auction site and the number of sweepstake entries or points available to the customer is determined by reference to that account. The various configurations of servers and other equipment used to implement various embodiments will be discussed in greater detail below with reference to the figures.

In an embodiment, the invention contains an accounting element that allows direct purchase of additional bids from the sweepstakes site. For example, the customer may win $20.00 in the sweepstakes. Instead of going through the steps to “cash in,” the customer may simply click a button that allows him or her to buy additional bids with the amount of money that the customer just won. No money physically changes hands. Rather, the transaction is performed digitally in the system by converting the money in the customer's account to bid credits and additional sweepstakes entries.

It will be evident to those of skill in the art that this invention could be used on a small scale, e.g., from a single location with a few terminals or on an international platform incorporating multiple languages, multiple sites and auctions coupled with a very large number of sweepstake games. This invention allows for simplicity of use for the customer along with the essential accounting measures needed to keep track of potentially millions of customers and their transactions.

Finally it should be noted that this invention is not limited to a penny auction site (or digital forum) or even to sweepstakes games. This invention could be used for sites that provide for transactions that do not involve auctions. The dual monitoring aspect of the invention could be used, for example, with someone buying a product on a conventional merchant site. Each time they buy something, the customer receives credits or chances for a sweepstakes type game. On the other hand, the site could be a penny auction site and, instead of sweepstakes, the other side could be privileges to view an entertainment site that has short digital videos.

With respect to the “dual monitoring” feature mentioned above, the viewing may be expanded in an embodiment of the invention beyond a penny auction side and a sweepstakes side and include a third viewing portal for constantly monitoring the customer's account information for example. This allows a customer quick access to the information and would allow them to buy additional bids when necessary. A fourth or even additional “same screen viewing/interactive” portals can also be employed. These may incorporate timing devices, other games, news, etc.

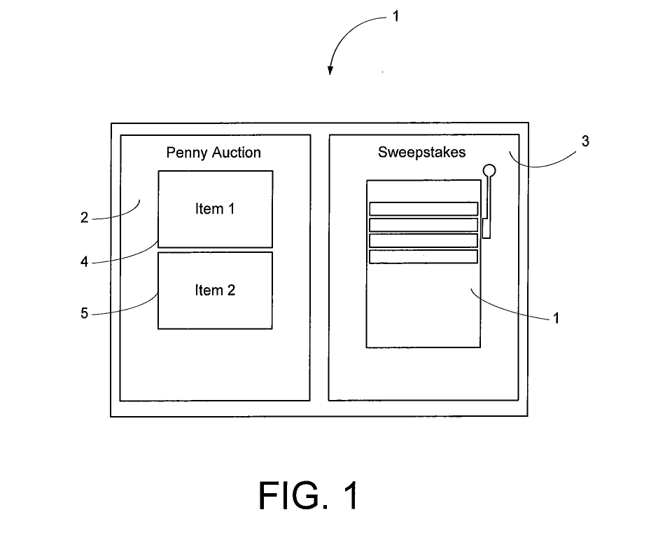

Turning to the figures, FIG. 1 is a dual monitoring display in accordance with an embodiment of the disclosure. As can be seen the display 1 includes first side 2 on which the penny auction information is displayed and a second side 3 on which the sweepstakes information is displayed. By way of example and not limitation, the penny auction side 2 of the display 1 may show a first item 4 being bid upon and a second item 5 being bid upon. It will be appreciated that a lesser or greater number of items may be shown.

The display 1 also includes, in the second side 3, a sweepstakes type game 6. In the illustrated embodiment of the invention, the sweepstakes game simulates a slot machine, but it will be appreciated that the sweepstakes game may take any suitable form that allows the user to easily enter and determine if they have won. For example, the user may click the slot machine handle or one of the display lines to reveal whether they have won.

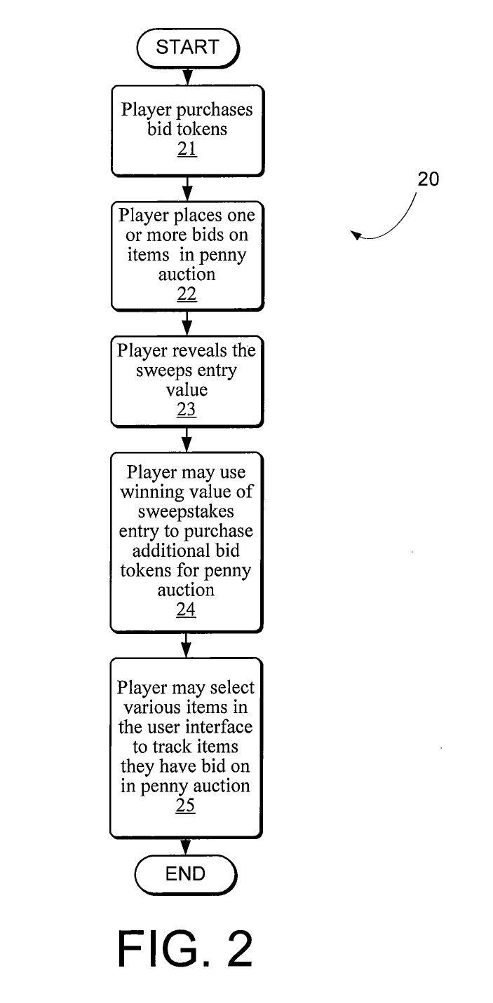

FIG. 2 is a flow chart showing a process 20 of enabling the integrated play of the sweepstakes with the transactions of the penny auction. At stage 21 of the process 20, the player purchases bid tokens. The purchase may be via a cashier, online or prepaid bid token card. The player then places one or more bids on items as desired in the penny auction at stage 22. The player is awarded one or more sweepstakes entry for their bid or purchase, and may then reveal the sweeps entry value at stage 23 in the second portion of the dual viewing screen. As noted above, the revealing of numbers, letters, or other indicia in the sweepstakes portion may be by any suitable means, including simulated games etc.

At stage 24, the player may use the winning value of the sweepstakes entry to purchase additional bid tokens to be used at the penny auction. Alternatively, the player may directly win additional bids as a result of winning the sweepstakes. The player may select various items in the user interface, e.g., to track items they have bid on, at stage 25.

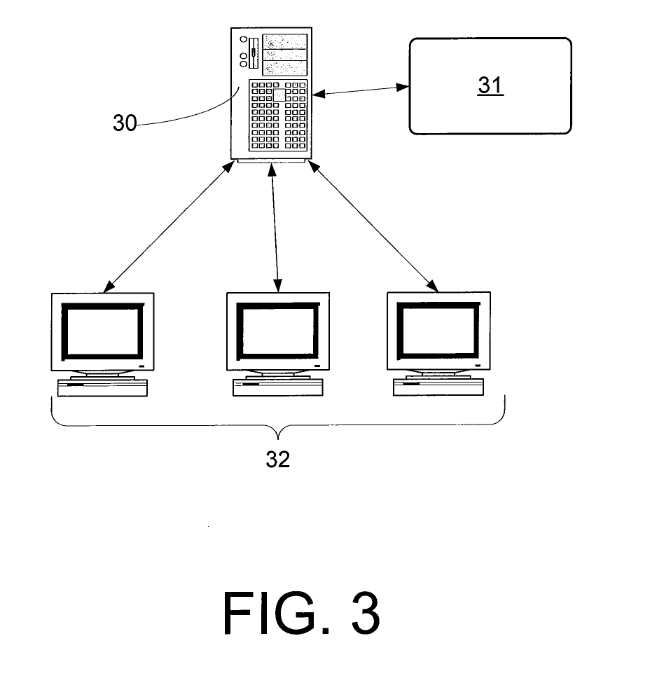

FIG. 3 is a schematic network diagram showing network components and configurations in an embodiment of the invention. The illustrated embodiment of the invention shows a basic model. The basic model includes one location with a local server 30 used for the penny auction and sweepstakes games. Players purchase bid tokens at the Point of Sale 31, place bids on items in the penny auction at the game consoles 32 and play the sweepstakes games to reveal the entry amounts. The process allows the players to purchase Bid tokens and have the sweepstakes entries placed in the gaming system. In the game system, player may purchase additional bid tokens with winnings from the Sweepstakes systems for example.

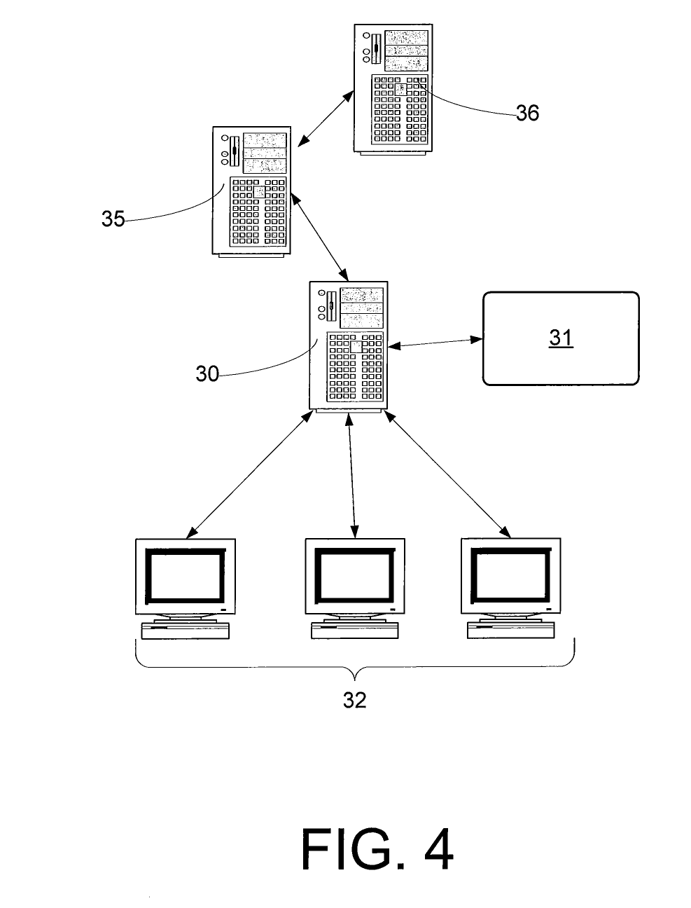

FIG. 4 is a schematic network diagram in an alternative embodiment of the invention. The alternative model includes the features of the network of FIG. 3 but additionally includes an internet data base 35 as well as a penny auction website server 36. In this model when a player purchases bid tokens, the internet data base 35 is updated with the bid tokens and sweep entries. Further, in this model, the player may place bids on items on the game console 32 or at the penny auction site 36.

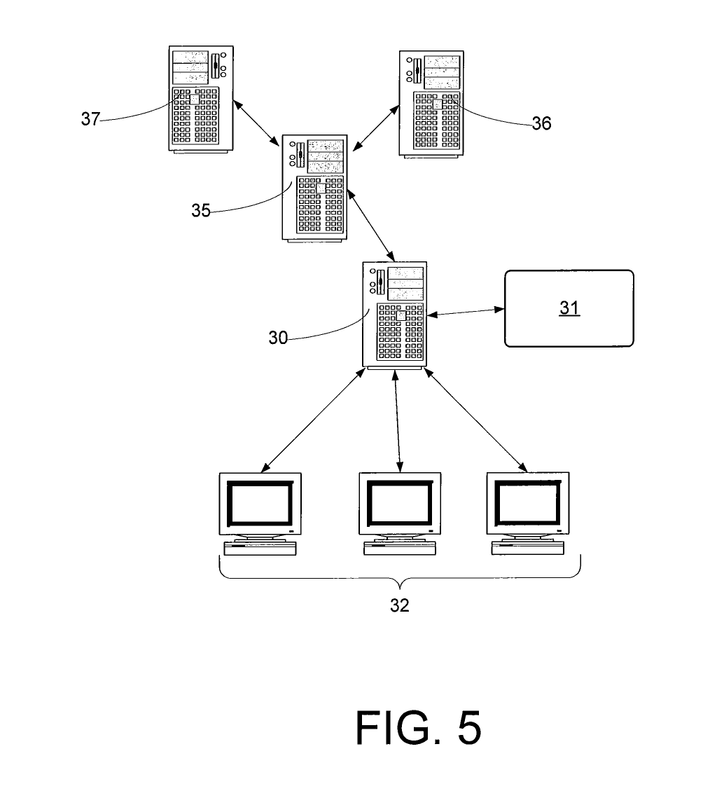

An additional model is shown in the network diagram of FIG. 5. In particular, in addition to the items shown in FIG. 4, the model of FIG. 5 includes a sweepstakes website server 37 interface to the internet database 35. This model allows players to reveal sweep entries on a website.

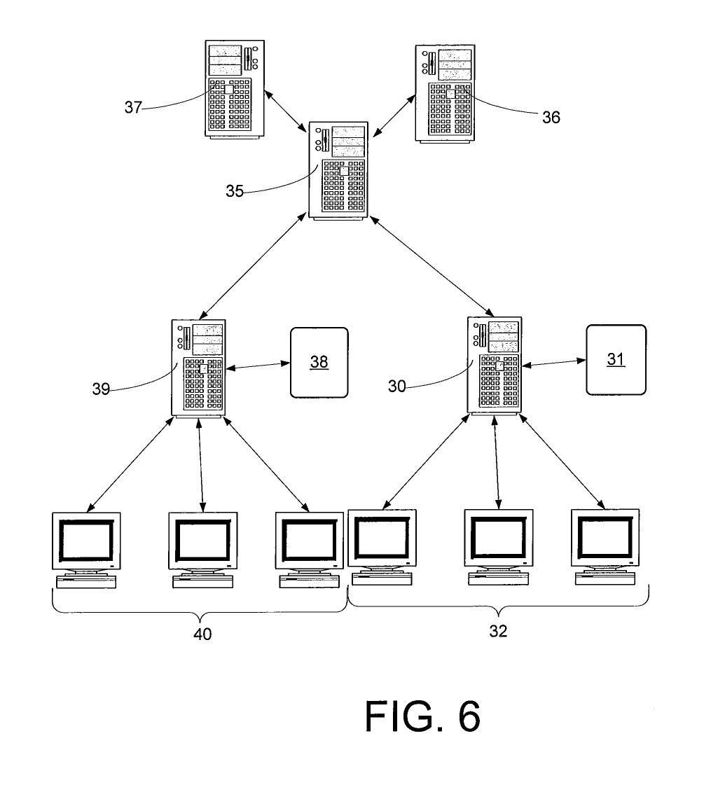

In another embodiment of the invention there are multiple locations connection to the internet data server, with one penny auction site and one Sweepstakes games site connecting to a central internet data server. This configuration is shown in FIG. 6. In particular, in addition to the elements shown in FIG. 5, the system also includes an additional point of sale 38, local game server 39, and game consoles 40.

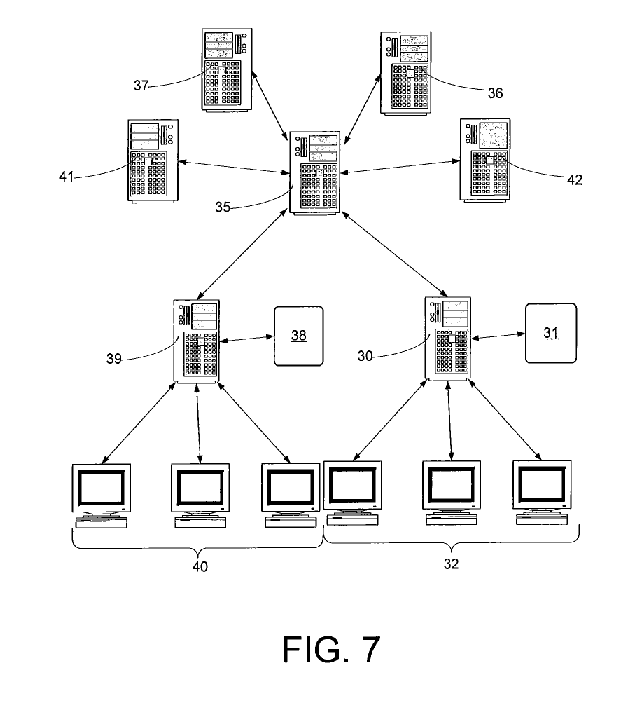

In another model there are multiple locations connecting to an internet data server, with multiple penny auction sites and Sweepstakes games sites connecting to a central internet data server. This configuration is shown in FIG. 7. In the illustrated embodiment of the invention, in addition to the elements shown in FIG. 6, the system includes an additional penny auction website 41 and an additional Sweepstakes game website 42.

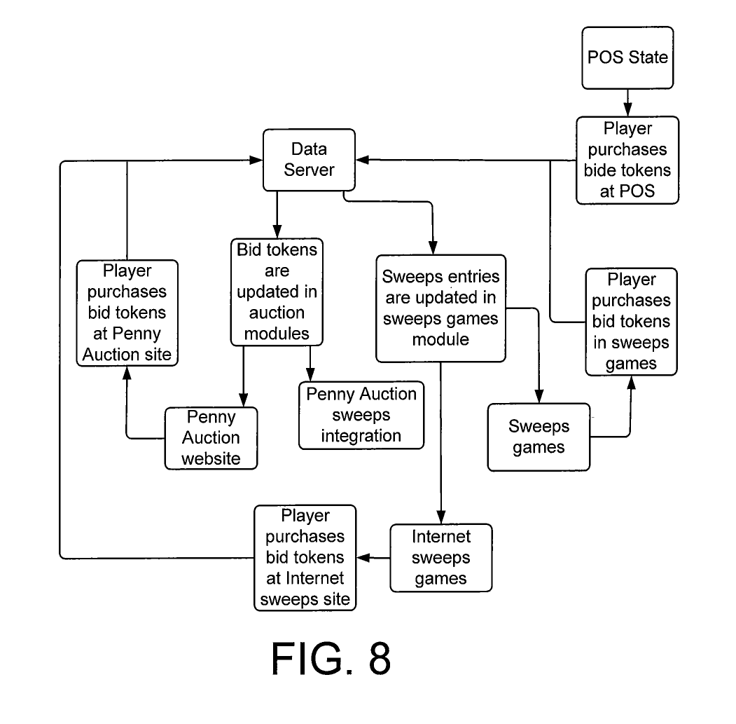

Finally, FIG. 8 is a data flow diagram showing the flow of data and updates in an embodiment of the system with respect to acquiring bid tokens and sweepstakes entries. The data flow begins with a user purchasing bid tokens at a point of sale, at which point the data server is updated. The user may instead purchase tokens at the penny auction site, or may acquire tokens through the sweepstakes. In any case, the bid token amount is updated in an auctions module and a sweepstakes entries value is updated in a sweeps game module. As the player utilizes tokens and sweepstakes entries, the bid token amount and sweepstakes entries values are updated.

It will be appreciated by those of skill in the art that the computers, consoles and monitors discussed herein are computerized machines operating by executing computer-executable code read from a nontransitory computer-readable medium. Suitable computer-readable media include hard drives, flash drives, optical drives, RAM, ROM, PROMs and other nontransitory computer-readable media.

While only certain embodiments have been set forth herein, alternatives and modifications will be apparent from the above description to those of skill in the art. These and other alternatives are considered equivalents and within the spirit and scope of this disclosure and the appended claims.

What is claimed is:

1. A method of integrating a penny auction and a sweepstakes, the method comprising:
presenting a split screen view to a user, with the split screen view containing a first portion and a second portion, the first portion displaying a penny auction and the second portion displaying a sweepstakes game;
receiving a request from the user to purchase one or more bids for use on the penny auction in the first portion of the split screen view; and
based on the received request, awarding the user one or more entries for the sweepstakes in the second portion of the split screen display.

2. The method of integrating a penny auction and a sweepstakes according to claim 1, wherein the first portion and the second portion are of approximately equal size.

3. The method of integrating a penny auction and a sweepstakes according to claim 1, wherein the first portion and the second portion are unequal in size.

4. The method of integrating a penny auction and a sweepstakes according to claim 1, wherein the split screen view contains a third portion in addition to the first and second portions.

5. The method of integrating a penny auction and a sweepstakes according to claim 1, further comprising detecting that the user has won the sweepstakes and in response to the step of detecting, offering the user a prize.

6. The method of integrating a penny auction and a sweepstakes according to claim 5, further comprising receiving a request from the user to exchange the prize for bid tokens usable on the penny auction.

7. The method of integrating a penny auction and a sweepstakes according to claim 1, wherein presenting the split screen view to the user comprises presenting the split screen view on a computer associated with the user.

8. The method of integrating a penny auction and a sweepstakes according to claim 1, wherein presenting the split screen view to the user comprises presenting the split screen view on a console associated with an operator of the penny auction.

9. A nontransitory computer readable medium having thereon instructions for performing a method of integrating a penny auction and a sweepstakes, the instructions comprising:
instructions for presenting a split screen view to a user, with the split screen view containing a first portion and a second portion, the first portion displaying a penny auction and the second portion displaying a sweepstakes game;
instructions for receiving a request from the user to purchase one or more bids for use on the penny auction in the first portion of the split screen view; and
instructions for awarding the user one or more entries for the sweepstakes in the second portion of the split screen display based on the received request.

10. The nontransitory computer readable medium according to claim 9, wherein the first portion and the second portion are of approximately equal size.

11. The nontransitory computer readable medium according to claim 9, wherein the first portion and the second portion are unequal in size.

12. The nontransitory computer readable medium according to claim 9, wherein the split screen view contains a third portion in addition to the first and second portions.

13. The nontransitory computer readable medium according to claim 9, further comprising instructions for detecting that the user has won the sweepstakes and in response to the step of detecting, offering the user a prize.

14. The nontransitory computer readable medium according to claim 13, further comprising instructions for receiving a request from the user to exchange the prize for bid tokens usable on the penny auction.

15. The nontransitory computer readable medium according to claim 9, wherein the instructions for presenting the split screen view to the user comprise instructions for presenting the split screen view on a computer associated with the user.

16. The nontransitory computer readable medium according to claim 9, wherein the instructions for presenting the split screen view to the user comprise instructions for presenting the split screen view on a console associated with an operator of the penny auction.

17. A method of providing an integrated transaction and game comprising:
displaying a first screen to a user, the first screen showing a transaction;
displaying a second screen to the user, the second screen showing a game; and
in response to user activity in the first screen relative to the transaction, providing the user with access to play the game shown in the second screen.
